(19) United States
(12) Patent Application Publication
(10) Pub. No.: US 2010/0061231 A1
(43) Pub. Date: Mar. 11, 2010

(54) MULTI-DOMAIN NETWORK AND METHOD FOR MULTI-DOMAIN NETWORK

(76) Inventors: Janos Harmatos, Budapest (HU); Istvan Godor, Budapest (HU); Alpar Juttner, Erd (HU)

Correspondence Address: ERICSSON INC., 6300 LEGACY DRIVE, M/S EVR 1-C-11, PLANO, TX, 75024, US

(21) Appl. No.: 12/312,349

(22) PCT Filed: Nov. 6, 2006
(86) PCT No.: PCT/EP2006/068148

§ 371 Date: Nov. 6, 2009

(51) Int. Cl. H04L 12/56; H04L 12/26

(52) U.S. Cl. 370/228; 370/400

(57) ABSTRACT

Each domain of a multi-domain network collects intra-domain routing information relating to that domain and makes a reduced view of that information available to other domains of the network, and in which each domain of the network uses its own intra-domain routing information together with the reduced-view routing information from the other domains to form a logical view of the network so as to enable that domain to make an end-to-end route selection decision.

### BACKGROUND OF THE INVENTION

1. Field of the Invention

The present invention relates to a multi-domain network and a method for use in a multi-domain network.

2. Description of the Related Art

In a multi-domain network there is provided a multi-connected network of different Autonomous Systems (AS). In a multi-provider environment, each AS or groups of aSs belong to different, independent network providers.

Such types of network do not exist at present to any large extent, owing in large part to the ubiquitous hierarchical structure of the current Internet. However, in the near future, multi-domain network with a flat connection structure will come to the fore in telecommunications. With such a structure, different operators on the same level will connect to each other's network and offer transport services with different Quality of Service (QoS) guarantees.

However, the above new network structure causes some new problems and issues in the area of routing and resource allocation. It is desirable to address these problems and issues.

### SUMMARY OF THE INVENTION

According to a first aspect of the present invention there is provided a method for use in a multi-domain network environment, in which each domain of the network collects intra-domain routing information relating to that domain and makes a reduced view of that information available to other domains of the network, and in which each domain of the network uses its own intra-domain routing information together with the reduced-view routing information from the other domains to form a logical view of the network so as to enable that domain to make an end-to-end route selection decision.

The logical view formed at each domain may comprise a plurality of intra-domain links between respective pairs of nodes of that domain.

Each intra-domain link may be a real and direct link between nodes.

The logical view formed at each domain may comprise a plurality of virtual intra-domain links for each other domain, each virtual link representing one or more real links.

The reduced-view routing information made available by a domain may comprise routing information relating to each of the virtual intra-domain links for that domain.

The logical view formed at each domain may comprise a plurality of inter-domain links between respective pairs of domain border routers.

All domain border routers of the network may appear in the logical view.

The domain border routers may be responsible for making the reduced-view information available to other domains of the network.

Each virtual link may be between two different domain border routers associated with the domain concerned.

The logical view formed at each domain may comprise a full-mesh topology in relation to the domain border routers of the other domains.

Each link may be associated with a respective administrative weight for use in the route selection decision.

Each administrative weight may carry information about properties of each real link represented by that administrative weight.

An administrative weight associated with a virtual link may be determined based on a sum of the respective administrative weights of each real link represented by that virtual link.

Each virtual link may represent a shortest path between the two end nodes for that link.

Each weight may comprise a vector of weights.

The domain border routers may be responsible for determining the virtual links and calculating the weights.

A respective scale value may be maintained for each domain, with the weights in each domain being scaled in dependence on the scale value for that domain before use in the route selection decision.

Each virtual link may be associated with a respective weight relating to a primary path for that virtual link and a different respective weight relating to a backup path for that virtual link.

A route may be selected taking account of both the primary path and the backup path of each virtual link on the route.

A shared protection scheme may be applied when calculating the backup path for each primary path.

The traffic capacity of each link may be allocated between a first part for handling primary traffic and a second part for handling backup traffic.

The second part may be shared between intra- and inter-domain protection.

A communication failure occurring on the selected route within a domain may be handled by that domain, independently of the other domains.

A communication failure occurring on the selected route between domains may be handled by an alternative end-to-end protection path.

If a problem is realised during resolution of the selected route, the originating node may be notified and, unless the originating node accepts the problem, a new route may be selected.

The route selection decision may be made according to a shortest path algorithm.

Each domain of the network may be of a type that is not predisposed towards sharing its intra-domain routing information with other domains of the network.

The route selection decision may be one based on Quality of Service.

The intra-domain routing information for each domain may also comprise resource information relating to that domain, so that the logical view of the network formed at each domain may enable that domain to make an end-to-end route selection and resource allocation decision.

At least some domains may belong to different respective operators.

A common intra-domain routing protocol may be used in the network.

According to a second aspect of the present invention there is provided a multi-domain network in which each domain of the network is arranged to collect intra-domain routing information relating to that domain and to make a reduced view of that information available to other domains of the network, and in which each domain of the network is arranged to use its own intra-domain routing information together with the reduced-view routing information from the other domains to form a logical view of the network so as to enable that domain to make an end-to-end route selection decision.

According to a third aspect of the present invention there is provided an apparatus for use in a domain of a multi-domain network, the apparatus being provided by one or more nodes of that domain and comprising means for: collecting intra-domain routing information relating to that domain, making a reduced view of that information available to other domains of the network, and forming a logical view of the network using the collected intra-domain routing information together with reduced-view routing information from the other domains so as to enable an end-to-end route selection decision to be made based on the logical view.

The apparatus may be provided by one or more domain border routers of that domain. The route selection decision may be made by a domain border router or it may be made by another node within the domain, such as a source node.

The apparatus may be provided by a single network node. If, on the other hand, the apparatus is provided by a plurality of network nodes, an appropriate method for exchanging information between them would be provided.

According to a fourth aspect of the present invention there is provided a program for controlling an apparatus to perform a method according to the first aspect of the present invention, or which, when run on an apparatus, causes the apparatus to become apparatus according to the second or third aspect of the present invention.

The program may be carried on a carrier medium.

The carrier medium may be a storage medium.

The carrier medium may be a transmission medium.

According to a fifth aspect of the present invention there is provided an apparatus programmed by a program according to the fourth aspect of the present invention.

According to a sixth aspect of the present invention there is provided a storage medium containing a program according to the third aspect of the present invention.

### BRIEF DESCRIPTION OF THE DRAWINGS

FIG. 1A illustrates a flat network topology before aggregation according to an embodiment of the present invention;

FIG. 1B illustrates a logical network topology after aggregation according to an embodiment of the present invention;

FIG. 2 illustrates the concept of capacity sharing in one embodiment of the present invention;

FIG. 3 illustrates an example European network topology; and

FIG. 4 illustrates some results of a performance evaluation carried out on an embodiment of the present invention.

### DETAILED DESCRIPTION OF THE PREFERRED EMBODIMENTS

An embodiment of the present invention concerns multi-domain networks, described briefly above, that have a flat connection structure, and in which different operators on the same level will connect to each other's network and offer transport services with different Quality of Service (QoS) guarantees. An integrated route management/traffic engineering solution is proposed (route selection with resilience) for guaranteeing the effective inter-working of the providers in order to provide end-to-end QoS. Before a detailed description of a network embodying the present invention, an analysis of the current technologies will be provided, since at least part of the invention lies in a clear appreciation of the prior art and the problems associated therewith. Differences between the prior art and embodiments of the present invention are highlighted.

Today, the most widespread intra-domain routing protocol is the Open Shortest Path First (OSPF) protocol, while the Border Gateway Protocol (BGP) is a de facto inter-domain routing protocol in the Internet. OSPF is an effective, robust intra-domain link-state routing protocol, in which the route decision is based on administrative link weights. These weights can be related to link delay or utilization, consequently OSPF is able to provide QoS routing. During the continuous growth of Internet BGP has proven to be a resilient inter-domain routing protocol. The most important strengths of BGP are the scalability and stability even at Internet scale, and its policy-based routing features. Policy based routing allows each administrative domain at the edge of a BGP connection to manage its inbound and outbound traffic according to its specific preferences and needs.

The afore-mentioned routing protocols/solutions fit the current Internet architecture, but in a multi-operator, multi-domain, multi-service (with QoS features) based architecture they cannot provide the needed network efficiency. The most important bottlenecks of the current solutions that will appear in next generation long-haul networks are as follows:

Firstly, although OSPF is an efficient intra-domain routing protocol and it can be used even for intra-domain QoS routing, the routing information cannot be shared through the entire network, it can be used only in the current domain.

Secondly, BGP completely hides the state of intra-domain resources within every AS. This causes that it very difficult to select a route, which is able to provide the sufficient QoS.

Thirdly, in many cases BGP requires tens of minutes to recover from a route or a link failure. In case of providing QoS such large recovery time is not acceptable.

Fourthly, even though BGP allows an Autonomous System (AS) to flexibly manage its outbound traffic, it has insufficient degree of control to manage and balance how traffic enters the AS across multiple possible paths.

Fifthly, each BGP router only advertises the best route it knows to any given destination prefix. This implies that many alternative paths that could have been potentially used by any source of traffic will be unknown because of this pruning behaviour inherent in

BGP.

The goal with an embodiment of the present invention is not to describe a new routing protocol, rather to propose a high-level description of a route management solution, which can be used for solving Traffic Engineering problems.

From a general point of view, a significant problem in a multi-domain environment is that of spreading the different kind of network state description information (like OSPF and BGP link weights, free resources, QoS parameters, failures, etc). From a routing point of view, different kinds of information aggregation strategies have been investigated, but they cannot be applied here for solving the entire problem.

If a multi-provider environment is considered, then the situation becomes more complicated. The providers can build networks with different topology, furthermore, they can apply different OSPF weight system, QoS classes or resource allocation schemes. In this case a further problem is that the operators do not want to share all information between each other (especially routing, traffic information—which is required to find optimal end-to-end path).
An embodiment of the present invention provides a solution based on the known topology aggregation method, extending with special options in order to fulfil the requirements of multi-domain environment. The essence of a proposal embodying the present invention is that each domain collects its intra-domain routing and resource information, then makes a reduced (or less detailed) view of these data and distributes it over the other domains. Using this reduced information together with the more detailed intra-domain information all nodes in the network is able to build a logical (or aggregated) view of the entire network, which is enough to select a path with the required QoS for a demand. The reduced network view supports that the domains do not want to share all information with the others. On the other hand this kind of aggregation results that some information will be available about each domain for the others, which provides that end-to-end path selection method can be applied.
An embodiment of the present invention also provides a so-called weight harmonization method, which enables the providers to use their own weighting strategies in their domain, but the route decision based on the aggregated topology will work correctly. Of course this model is working effectively only if the domains propagate real data about themselves, but the weight harmonization method is able to filter the non-real routing information during short time.

Especially in the multi-provider case, it is possible that the different providers use different type of resilience strategies in their domains. For example a provider may apply 1+1 dedicated protection, but the next one towards the destination node applies only some kind of on-line restoration mechanism. This causes that different grade of protection is provided through different sequence of domains. Another problem is that a change in the routing may cause change in the grade or type of protection. To sum up: the unknown topologies, traffic volume (link loads) and the different routing policies domain by domain makes the planning of end-to-end resilience very complicated.

The other problem belongs to the inter-domain links: Protection against failure of these links requires extra backup capacity reservation in all domains. The main problem here is how these resources can be divided between the providers in a fair way.
An embodiment of the present invention proposes a resilience mechanism that provides end-to-end resource-saving protection against both intra- and inter-domain link and node failures. The method use resource sharing, therefore protection against inter-domain links requires minimal additional resources.

In the literature, there are several papers dealing with topology aggregation based routing. A brief survey is provided below of the most important ones, concentrating on the differences between the existing works and proposals embodying the present invention.

Many papers deal with the problem of aggregating the topology, however the most important reason of the aggregation is the minimization of the entries in the routing tables or the bandwidth needed to carry the routing information update messages over the network (see: [a] Fang Hao, Ellen W. Zegura, “On Scalable QoS Routing: Performance Evaluation of Topology Aggregation”, Proceedings of IEEE Infocom, 2000. Tel Aviv, Israel, Mar 2000; and [b] Venkatesh Sarangan, Donna Ghosh and Raj Acharya, “Performance Analysis of Capacity-aware State aggregation for Inter-domain QoS routing”, Globecom 2004, Dallas, December 2004, pp. 1458-1463). Although aggregation can decrease the entries in the routing tables significantly, and some QoS parameters can be considered in the routing decision (so called QoS-routing), but in itself it cannot provide end-to-end QoS.
An embodiment of the present invention propose an aggregation technique that is able to carry information for end-to-end QoS route decision.

Many proposals are based on single-domain network environment using the existing hierarchical aggregation capabilities of Private Network to Network Interface (PNNI) or

OSPF protocols (see Yuval Shavitt, “Topology Aggregation for Networks with Hierarchical Structure: A practical Approach”, 36th Annual Allerton Conference on Communication, Control and Computing, September 1998).
In an embodiment of the present invention, the specific issue of a multi-domain, multi-provider network environment is considered.

Furthermore, the existing aggregation solutions do not consider the inter-working of intra- and inter-domain routing protocols.
In an embodiment of the present invention, the basic issue is how the inter- and intra-domain routing protocols share and handle the routing information, building up the aggregated view of the whole network.

Another limitation of the existing solution is the pre-defined topology of the aggregated network, such as tree, star, full-mesh (see: [a]Yuval Shavitt, “Topology Aggregation for Networks with Hierarchical Structure: A practical Approach”, 36th Annual Allerton Conference on Communication, Control and Computing, September 1998; [b] Fang Hao, Ellen W. Zegura, “On Scalable QoS Routing: Performance Evaluation of Topology Aggregation”, Proceedings of IEEE Infocom, 2000. Tel Aviv, Israel, Mar 2000; and [c] Venkatesh Sarangan, Donna Ghosh and Raj Acharya, “Performance Analysis of Capacity-aware State aggregation for Inter-domain QoS routing”, Globecom 2004, Dallas, December 2004, pp. 1458-1463). Simple topologies, like different types of stars and trees cannot be used if it is wanted to provide end-to-end QoS guarantees (in case of these topologies there is an information loss in the aggregation process). In the article entitled “Routing with Topology Aggregation in Bandwidth-Delay Sensitive Networks” by K-S. Lui, K. Nahrstedt, and S. Chen, IEEE/ACM Transactions on Networking, February 2004, Vol. 12, No. 1, pp. 17-29, the authors propose a scheme for information loss free network representation using star topology expanded with special links, called bypass links. The main drawback of the method is that very complicated computations are required in case of each update and that the aggregated topology can change significantly in case of updates. As a result, the applicability of the method in real network environment is limited.

Furthermore, the application of pre-defined topologies is limited in case of multi-provider network environment.
In contrast to the existing solutions, an embodiment of the present invention enables operators to apply any arbitrary aggregated topology.

In the article entitled “Macro-routing: a new hierarchical routing protocol” by Sanda Dragos and Martin Collier, presented at Globecom 2004, Dallas, Tex., 29 Nov—3 Dec 2004, the authors propose an automatic route-discover scheme, which use so-called mobile agents to find an appropriate path over a domain and the aggregated topology is built up using these paths. The problem with the method is that the routing information updates require significant time.
Instead of this, an embodiment of the present invention proposes an update process that is very similar to the OSPF flooding mechanism in order to achieve a short update time.

It is also important to appreciate that there is no paper in the literature that deals with resilience issues in the case of topology aggregation.
In an embodiment of the present invention, in addition to the topology aggregation aspect, it is proposed a scheme and method for providing end-to-end resilience in multi-domain, multi-provider network environment.
   Summarising the above, an embodiment of the present invention provides a route selection and resource allocation method that can be applied in multi-domain network environment. The basic idea is to use a virtual aggregated network topology in the routing decision, and to provide a method how to find an end-to-end path with the required QoS. The routing algorithm can be extended with a new resilience technique, which fits to the multi-domain network environment.

Three main issues are addressed by an embodiment of the present invention:

Firstly, a traffic engineering solution is provided in multi-domain environment. The main part of this solution in one embodiment consists of a link-state type (link weights) aggregated description of the intra-domain routing information and the flooding mechanism of this information through the network. This aggregated routing information is then combined by the adequate intra-domain routing information forming an overall network view in all nodes. A further new feature is that the above routing information does not determine a priori the path of a demand. Any source node can modify the link weights according to its additional information or existing knowledge of the previous route selection procedures.

Secondly, an algorithmic solution is proposed for the harmonization of aggregated weights system of different domains. The modification of the weight system caused by successful or unsuccessful demand establishment is also the part of the weight harmonization methodology.

Thirdly, a resilience methodology is also proposed, which conforms to the above model, but it can also be applied separately.

A more detailed description of an embodiment of the present invention will now be provided, based on the following definitions and assumptions:
Domain: a single Autonomous System (AS), which belongs to a single operator (network or service provider), and where a common intra-domain routing protocol is used. For example a domain could be a midlevel ISP, but it could also be a national backbone network.
Network: a collection of domains operated by different providers. A network could be an international long-haul backbone network, but it could be a core network of midlevel ISPs.
Intra-domain link: a link whose both end nodes belong to the same domain.
Inter-domain link: a link whose end nodes belong to different domains.
Intra-domain router (IDR): a router whose all interfaces are connected to intra-domain links and on the router only intra-domain routing protocol (e.g. OSPF) is run. Since an IDR could be a gateway towards lower level access nodes the traffic flow in the network are originated and terminated in IDRs.
Domain Border Router (DBR): a router whose interfaces connect to both intra- and inter-domain links. In this context a DBR runs both intra and inter-domain routing protocol and responsible for maintain and update administrative weights (used in the routing decision) on the incoming inter-domain links.
Intra-domain traffic: from the view of a domain, a traffic flow is inter-domain if its source or destination node is in the current domains.
Inter-domain traffic: a traffic flow is inter-domain if neither its source nor its destination node is in the current domain.
Virtual link: a link in the aggregated network topology.

The following assumptions are made regarding the network:
A domain consists of large number of nodes, in order to provide several alternate intra-domain routes (with different QoS parameters) and provide the ability to apply resilience strategies.
The network contains numerous domains, in order to provide alternate inter-domain paths.
An operator wants to hide his accurate domain topology and current traffic situation from the other operators, but he is disposed to share some aggregated information with the others, which can be used in end-to-end routing decision.
Only a single (node or link) fault is considered.

### Creating the Aggregated Topology

In order to select an optimal route in the network, the entire network topology must be known in order to be able to select appropriate paths. However, this would result in an unmanageable amount of routing information and, moreover, the operators are often unwilling to provide information about his internal-domain topology and routing strategy.

The solution proposed in an embodiment of the present invention is to use an aggregated virtual network topology to describe the multi-domain area and only this aggregated network topology and routing information is considered in the routing decision.

Some properties of the aggregated topology in an embodiment of the present invention are as follows:
All DBRs and all inter-domain links appear in the aggregated topology, however, the intra-domain topologies remain hidden.
In the aggregated topology the intra-domain connections between the DBRs are represented by a direct virtual link. Generally, between each DBR belonging to the same domain there is a direct virtual link, forming a full mesh interconnection of DBRs on the aggregated level. However, this is not mandatory, the current domain's right is to create the aggregated level topology about itself like sparse mesh, ring, tree or star.
Each virtual link in the aggregated topology has a (virtual) administrative weight, which is used in the end-to-end route selection process. It is a basic requirement for the domains to adjust the administrative weights on their virtual link in such a way that they carry information about the properties of the represented real connections.

In summary, the basic idea of topology aggregation is as follows. A domain naturally has all topology and routing information about itself, it sees an aggregated view about other domains in the network and it advertises an aggregated view about itself on the basis of the above criteria.

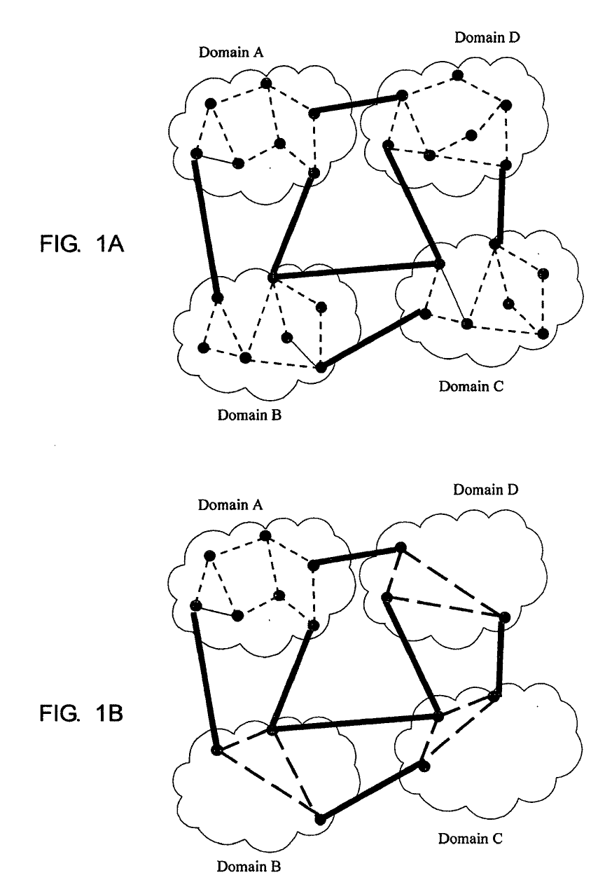

FIGS. 1A and 1B illustrate the concept of the topology aggregation from the viewpoint of Domain A. FIG. 1A illustrates the entire, flat network topology, while FIG. 1B illustrates the aggregated topology information from the point of view of Domain A. In this case, the aggregated domains (Domain B, C and D) are represented by a full-mesh topology consisting their original border routers.

The routing is based on the administrative weights of the links (see short-dashed lines for intra-domain links and solid bold lines for inter-domain links), therefore, adequate weights have to be calculated to the aggregated links (see long-dashed lines in FIG. 1B), which connect the border routers inside a domain. Since different operators can have different routing policies, the method of calculating these weights may be different from domain to domain. However, the best path for a demand is typically found by a shortest path-based routing algorithm, which ensures that the magnitude of the weight should in harmony in the network.

The weight could be the sum of the weights along the “shortest” path between a pair of border routers. Where the “shortest” path could represent, for example, the physically shortest not-overloaded path or the least loaded path according to the routing policy applied in a given domain.

If the operators would like to provide differentiated QoS services, then a simple number for a weight may be not enough to meet their wishes, but it is required that the weights are represented as a vector. This vector could contain the throughput, the delay or any other quality-related parameters between the two border routers of the domain represented the given link.

### Routing Information Computing, Flooding and Updating

More detailed information concerning the computing of routing information, flooding and updating will now be provided, summarizing the main steps of how to calculate the administrative weights in the aggregated topology and how to use them in the route selection.

In each domain the DBRs are responsible to setup the direct virtual links between each other in the aggregated level, compute the weight of the virtual links on the basis of the intra-domain link utilizations or other policy-based issues and forward the links state advertisement of the virtual links over the network similarly to the OSPF flooding mechanism.

### Building Up the Aggregated Network Topology

For the task of building up the aggregated network topology, in this embodiment the key equipments are the DBRs; they are responsible for building up peering connections with their neighbour DBRs, for agreeing on the aggregated topology of the domain it belongs to, and for distributing the link-state information about the links connected to them.

The main steps of the building up and the maintenance of the aggregated topology are summarized as follows:
1. Neighbour Peering: Peering can be made automatically, which means that the neighbour DBRs can discover each other using “Hello” messages. In this case, the intra-domain aggregated topology will be fully meshed, and all inter-domain links will appear in the aggregated topology. On the other hand, the DBR peering can be configured. This provides the operators of the domains with the possibility to build up an arbitrary intra-domain topology on the aggregated level.
2. Calculation of the weights of the virtual links: The DBRs calculate the intra-domain virtual link weight on the basis of the OSPF administrative weight of the intra-domain links (for details see below). Integer weights are assigned to the inter-domain links. These weights are distributed in the whole network. All virtual link weights are represented by a vector according to the description above under heading “Creating the aggregated topology”.
3. Flooding: Only the DBRs are authorized to flood link-state information through the network, but each nodes receives the messages and build up its own aggregated network topology database. (For more details see below under heading “Routing information flooding”.) In each domain there is at least one DBR-server (selected automatically, or preconfigured), which is responsible for sending the link-state information to all nodes in the current domain. To increase the reliability, more than one DBR-server can be selected. In this case the DBR-servers agreed a prioritization between each other and always the highest priority DBR-server acts.
4. By combining the intra-domain OSPF link-state advertisements and the aggregated network topology, each node will have a complete view on the network, which can be applied in the end-to-end routing decision process.

### Routing Information Computing

The routing information distributed in the network is simply the weight of the links in the aggregated topology. However, several considerations can be taken into the account in the way that these weights are computed. (Note that more efficient protection requires more information; see the description below under heading “Protection and resilience schemes”.) On the one hand, the weight calculation policy can be different for the real links and for the virtual links, and, on the other hand, the applied policy can be different in each domain. Some typical weights are considered below, and how they are mapped into the virtual links.

There are two typical weighting groups:
Delay-based weights such as:
   W=1, simply representing one hop per link
   W=delay
Utilization-based weights such as:
   W=const₁+const₂*(load/cap)
   W=const₁+const₂/(freecap+e)=const₁+const₂/(cap−load+e), where const₁ and const₂ can be any positive number and e is a proper small positive number.

In the case of an inter-domain virtual link, its weight could be the above mentioned link weights. An intra-domain virtual link represents some kind of shortest path between two DBRs, so there are several alternatives for weight calculation. Two main alternatives are:
Additive type: the weight is the sum of the weights along the shortest path. This alternative is typically combined with delay-based weights.
Bottleneck type: the weight is the most extreme weight along the shortest path. This alternative is typically combined with utilization-based weights, for example, the “maximal throughput” of the path that is the minimal free capacity along the path.

### Routing Information Flooding

Because the method according to an embodiment of the present invention is a link-state based routing, the synchronization of the distributed link-state databases is an important issue. To synchronize the databases a flooding mechanism is proposed that is similar to the known OSPF flooding.

The mechanism is as follows on the entire network level:

It is assumed that all nodes' databases are synchronized and in a domain there is a change on one link. It causes an intra-domain OSPF link-state advertisement and flooding process.

During the OSPF flooding, the DBRs' peers (whose aggregated level virtual link contains the current link) recognize that weights on a physical link have changed, so the weight of the adequate virtual links is not valid any more.

The source DBR(s) of the corresponding virtual link(s) updates the virtual link weight(s) according to the methods described above in the part headed “Routing information computing” and forming a link state update message and send it to all neighbours. The frequency of the virtual link weight updates need to fulfil different requirements as it is considered below in the description headed “Updating the aggregated link weights”.

The link state update message contains:
The new weight of the corresponding virtual link.
The ID of the DBR that generate the message.
A sequence number, which increased in case of each update. This sequence number helps to decide all nodes whether the incoming link state update message contain more recent data than what is stored in its database.

If a DBR gets a virtual link state update message from one of its neighbours, then it repackage the message, and put its router ID into the message, and send the message out on all interfaces, except the one on that the update message was received. At the same time the current DBR sends an acknowledgement back to the DBR, which sent the update message. During this procedure the DBR-servers in all domain will got at least one piece of the link-state update message. Then the DBR-servers repackage the message and send them directly to all nodes in the current domain. If a node got the update message it updates its local database. If there is more than one DBR-server in the domain, then the highest priority server will send out the information through the domain.

### Updating the Aggregated Link Weights

From the viewpoint of efficient route selection, it is important that the aggregated network view carries up-to-date utilization/delay/etc information about the real network. For that reason, it is a basic requirement to update the aggregated link weights at the required frequency. On the other hand, it is desirable to avoid insufficient large volume of administrative traffic related to the aggregated network topology.

If the demand arrivals/tear downs have low intensity, then these relatively infrequent events can trigger the corresponding DBR(s) to start an update process (triggered update). Otherwise, the DBR(s) start update process at predefined periods.

### Routing Resolution

With the knowledge of the virtual topology and the weights, the source node of a demand can calculate the appropriate route by performing a shortest path algorithm.

After the route is selected on the virtual topology, then the source of the demand sends a reservation request along the route. This message contains the virtual links, the required capacity (or additional QoS parameters) and the destination node. The resolution process consists of four blocks:
1. Source domain resolution: in the domain of the source node there is practically no resolution, since the topology is known there, so the reservation can be done.
2. Inter-domain link resolution: the two ending DBRs know that this link is also a real link, so the reservation can be done.
3. Intra-domain link resolution: between the two DBRs in the same domain there is a virtual link, which can be resolved by the DBRs with a shortest path algorithm based on the weight applied inside the domain, since both DBRs know the topology inside. After the intra-domain route is found, the reservation can be done.
4. Destination domain resolution: if the destination node equals the selected DBR of the domain, then the resolution is finished. Otherwise, the destination domain has to make a similar resolution between this DBR and the destination node as in step 3.

It can be seen that if the weights of the virtual links are properly calculated, then the route from the source to a DBR of the destination is optimal without seeing the details of the real route. Here a DBR selecting procedure is done, which is to choose the closest one by default, but this procedure can be completed to be optimal. If it is possible to poll the DBRs of the destination node about the weight of the route between them and the destination node, then the entire route will be optimal.

A particular resolution process can be the combination of the above steps as follows:
Intra-domain demand: the destination node is in the same domain as the source node, so only step 1 is needed.
Short-distance inter-domain demand: the destination node is in a neighbouring domain. Here step 1, 2 and 4 are needed.
Long-distance inter-domain demand: the demand goes through other domain(s). Here the process is the following sequence: step 1, 2, 3, (2, 3, . . . , 2, 3) , 2, 4. Note if the virtual intra-domain topology is not a full-mesh, then a sequence of step 3 may be needed instead of a simple step.

Note that inaccuracy problems in the updating procedure of the link weights may result that along the selected “virtual” route there are not enough free resources or the QoS requirements cannot be met in the underlying real network. After a notification step, a resilience process should be done in that case, which is detailed below in the description headed “Routing inaccuracy problems”.

### Protection and Resilience Schemes

The task of the protection is divided into two parts according to the place of the failure. Since the intra-domain territories are hidden from outside in the virtual topology, the failures evolve in these territories have to be solved within the domain (see below in the description headed “Intra-domain traffic protection”). Moreover, this property and the multi-operator environment imply that the operation of the protection and the resilience scheme is distributed. On the other hand, the protection of the inter-domain traffic (traffic on inter-domain links) should be solved by an agreement of the domains/operators (see below in the description headed “Inter-domain traffic protection”). This is realized as a parallel resource reservation beside the primary paths, however, the resources can be shared very effectively (for details see the description headed “Resource sharing”). Then some possible routing inaccuracy problems and the prevention of them are introduced (see the description headed “Routing inaccuracy problems”). Finally a weight harmonization method is proposed in order to avoid unbalanced inaccurate routing caused by the different weight calculation policies applied the different domains (see the description headed “Weight harmonization”).

### Combined Intra-Inter Domain Traffic Protection

The proposed technique combines the domain-by-domain and the end-to-end protection scheme:
Each domain protects the traffic on its links (see the description headed “Intra-domain traffic protection”). This provides fast restoration of traffic in case of intra-domain link failure. Failures can occur in more domains in the same time; domain-by-domain protection can be handled in this case, too.
The inter-domain links are protected by an end-to-end protection path (see the description headed “Inter-domain traffic protection”). It is assumed that the probability of inter-domain link failures is small, therefore, end-to-end protection (combined with resource sharing) could be a suitable solution for this failure scenario.

The proposed resource sharing technique (see the description headed “Resource sharing”) guarantees the minimal resource reservation for the protection at a given weighting.

In case of intra-domain protection, the routing resolution on intra-domain virtual links is extended to provide two independent paths between the DBRs instead of one path. In case of inter-domain link protection, however, the routing resolution remains the same.

### Intra-Domain Traffic Protection

A per-domain internal protection scheme is proposed, where each operator handles the intra-domain failures locally, independently from the other operators. In this scenario it can be assumed that the source node need not take actions against the failure (in fact, it is not even informed about a failure of this kind). Furthermore, the connections of the users are able to survive more than one failure if the failures occurred in different domains.

Beside the requirements on delay and capacity by a demand, the provisioning of QoS can also contain protection and resilience requirements, which practically means that different values are requested for the primary and the backup paths. Therefore, in a model embodying the present invention, the weight of the links in the virtual topology is given by two fields. One field for the primary and another field for the weight of the backup path. So in the case of intra-domain link resolution between two DBRs, two shortest paths are computed based on the two fields, a primary and a backup.

In the route selection process, a route can be chosen in such a way that both the primary and the backup path satisfy the demand. It can still happen that the domain cannot provide a backup path in the real topology when resolving the virtual link. Therefore, in the case of an intra-domain failure, a resolution process should be done, however, probably different paths are selected for the demands using the down virtual link in question.

Inter-Domain Traffic Protection

Demands may require protecting their traffic also in case of inter-domain link failure. So, in this case, two inter-domain link independent paths are calculated and reserved by the source node of the demand.

### Resource Sharing

It is a general requirement to keep the reserved resources at minimum. In the case of intra-domain protection, a shared protection scheme can be applied when calculating the backup paths for each primary path corresponding to each virtual intra-domain link.

In the case of inter-domain protection, the used intra-domain resources should be minimized. Since only one-failure-at-a-time scenario is concerned, the intra-domain backup resources can be freely used for inter-domain protection. In order to provide intra-inter sharing, it has to be indicated during the reservation process that this is the inter-domain backup path of a particular demand (“backup reservation”), so no extra protection is needed and can be shared with the intra-domain backup paths.

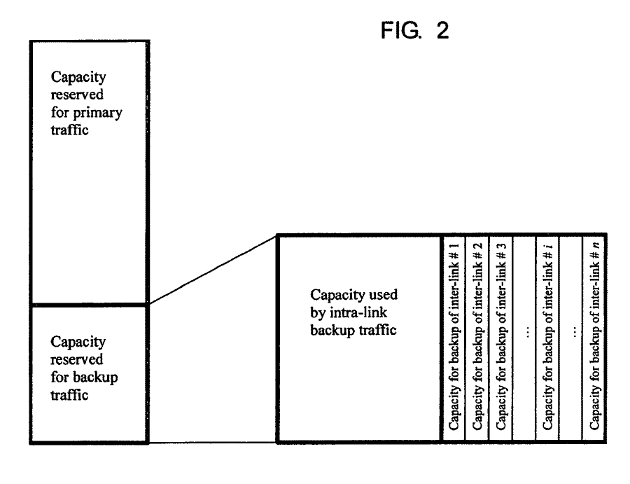

With additional indicators, the inter-domain link protection can be shared with each other. Then not only the “backup status” has to be indicated, but the list of the inter-domain links to whose failure the particular inter-domain backup path corresponds. In this case, the capacity reserved for protection proposes in the network can be shared between each inter-domain link failure. The way of sharing the capacity of a link is highlighted in FIG. 2. As it is depicted, the capacity of a link is divided into two parts.

The first part is reserved for primary traffic regardless of whether the link is an inter-domain or an intra-domain link.

The second part is reserved for the backup traffic and can be totally shared between intra-domain protection and inter-domain protection. Moreover, in both cases the full capacity can be shared between the demands going through or generated inside the particular domain. Furthermore, in the case of inter-domain protection, the capacity also can be shared between each inter-domain link failure as stated above.

### Routing Inaccuracy Problems

Distributed non-real-time link weight management system causes routing inaccuracy problems in practice. In the case of protection, these problems are twofold. Beside the insufficient free resources or unsatisfactory QoS provided in the underlying real network, these problems may affect both the primary and the backup paths. If such a problem is realized during the routing resolution, the source node is notified about the error (no resource, QoS or protection degradation). Unless the source accepts the error or degradation, new paths are selected on the virtual topology omitting the defectively resolved links.

Note that the update procedure of the link weights should be restricted to the proper level of the network. On the other hand, the update of the real weights is by definition restricted to each domain. Then the DBRs calculate the weights of the virtual link based on the above real weights and the updating of the virtual links should be limited to a flooding between the DBRs. Finally the DBR-servers will inform the nodes inside their domain about the weights in the virtual topology.

### Weight Harmonization

The routing algorithm highly depends on the weights assigned to the links of the aggregated topologies. These weights are obtained from the controlling parameters of the actual domain topologies. However, neither the way of setting these parameters nor the aggregating algorithms are standardized. This, however, may induce serious inconsistency in the aggregated topology. So the inter-domain traffic would be routed according incomparable sets of weights. If the range of the weights used by the domains differs, the routing will be done based on false information.

To overcome the above problem a scaling method is also proposed to handle this possible inconsistency. Therefore the routing engine maintains a floating-point scale-value C_{d} assigned to each domain d∈D. Then the propagated link weights are scaled by the corresponding scaling value, and the path allocation uses these scaled weights.

It is assumed that the inter-domain links are operated by their destination domain separately for both directions, therefore their weights are scaled according to this.

### Scale-Value Maintenance: Normalization

In order to avoid unstable weights, the following two normalization conditions apply:
To avoid big scale-values it is required that

$${\sum }_{d ∈ D} {C}_{d} = 1.$$

This automatically keeps the scale-values to be at most 1. The normalization is simply done by dividing all the weights by the value

$${\sum }_{d ∈ D} {C}_{d}$$

after each weight modification.
It is also wanted to avoid zero or near zero scale-values. For this, a lower threshold value

$${t}_{min} < \frac{1}{\vert D \vert}$$

is introduced and the scale-values are maintained to be at least tₘᵢₙ (a practical value for tₘᵢₙ might be around

$$\frac{1}{100 \vert D \vert} ) .$$

If some scale-values disobey this condition, the following normalization is applied:

$$• {σ}_{d}^{new} := \frac{{σ}_{d}^{old} + α}{1 + \vert D \vert α} , where α := \frac{{t}_{min} - min \{ {σ}_{d} \text{:} d ∈ D \}}{1 - {t}_{min} \vert D \vert} .$$

Note that, while this latter operation also preserves the first normalization condition, it is not true for the first normalization operation, i.e. it can result in weights below the lower threshold. So, the order of the normalization operations is important.

### Scale-Value Maintenance: Scale-Value Adjustments

Scale-values are modified by two basic operations: a set H⊂ D can be promoted or demoted by a given value μ>1.
Promote operation. The scale-values of each domain in H are divided by the value μ, and the scale-values are then normalized.
Demote operation. The scale-values of each domain in H are multiplied by the value μ, and the scale-values are then normalized.

Note that not only does the promote operation decrease the scale-values of the promoted domains but also it increases the others at the same time. Of course, the opposite is true for the demote operation.

### Scale-Value Updates

The update process of the scale values is based on the success of the demand allocation. Three strategies can be used here.
Positive feedback. When a new demand has to be routed, it is done using the current propagated weights and scale-values. If it is managed to allocate the necessary bandwidth on this path, the domains are promoted along this path with a certain fixed value μ^{pro}. If the bandwidth allocation failed, nothing is done.

Note, that if it was tried to immediately reallocate the demand, the same path would be got, so the bandwidth allocation would probably fail again. So, this scheme can only be applied if new demands appear very frequently in the network. This latter assumption ensures, that the scaling values will significantly change between two allocation trials of a certain demand. To sum up, this scheme would rather be considered as a theoretical possibility.
Negative feedback. This case is similar to the previous one, but here the scale values are modified on failures instead of on successes. So, when a new demand has to be routed, it is done using the current propagated weights and scale-values. If it is managed to allocate the necessary bandwidth on this path, nothing is done, and if it failed, the domains along this path are demoted with a certain fixed value μ^{dem}.

Because in a real life network the allocation failure should be significantly less frequent than the successful allocations, the proper value of μ^{dem} is much larger than μ^{pro}.
Mixed strategy. In this case, both the negative and the positive feedback are applied.

Note again, that a failure requires much larger reconfiguration of the scale values than the case of the successful allocations. Therefore, it is important to use μ^{dem} value that is much larger than μ^{pro}.

### Protocol Extension

The following summarises at least some of the protocol extensions proposed according to an embodiment of the present invention:
The DBRs build up peering with each other in a domain and are able to agree on the intra-domain aggregated topology. In each domain the DBRs designate the DBR-server.
The DBRs compute the weights of the intra-domain virtual link on the basis of the OSPF link weights of the domain.
The DBRs flood the intra-domain virtual link weights through the network.
The DBR-servers forward the virtual link state update information to all nodes in its the domain.
All nodes in the network receive the virtual link state update messages and build up the aggregated topology of the entire network and combine it with the intra-domain topology.
The nodes calculate the end-to-end path on the basis of the above combined aggregated topology.
The DBRs respond to polls asking the weight of the route between them and a node inside their domain.

### Performance Evaluation

In this part of the description, some numerical investigation of the proposed solution is presented.
1. The performance of the proposed aggregated topology based route selection and the performance of route selection in case of flat topology is compared from the viewpoint of blocking probability.
2. The proposed resilience mechanism will be examined from the viewpoint of recovery time and capacity sharing between the intra- and inter-domain traffic protection.

### Routing Efficiency

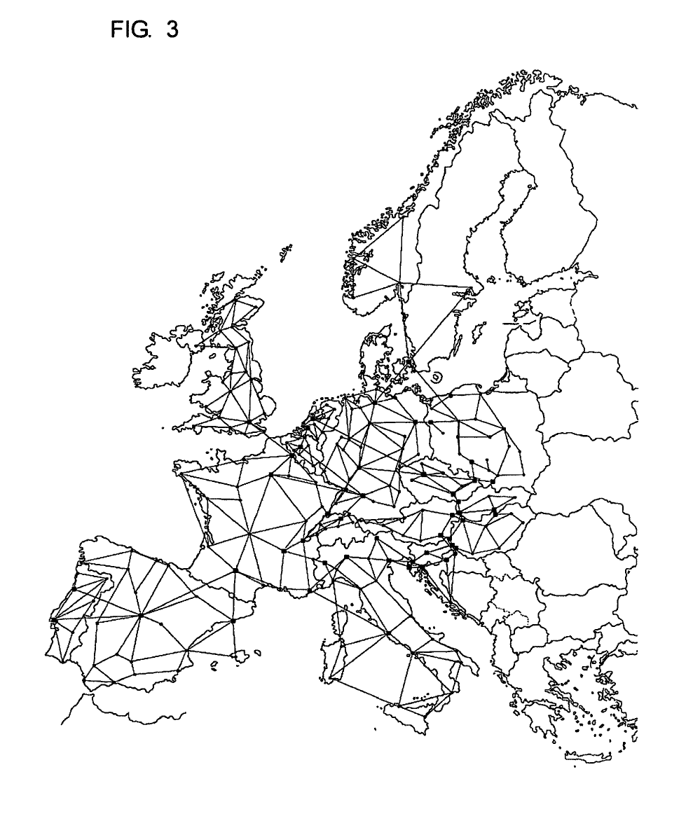

It is important to see the effect of the topology aggregation and the inaccuracy of the routing (caused by the not-always up-to-date weights) in order to analyze the efficiency of the routing. The tests used a sample European network topology shown in FIG. 3.

Four different cases were analyzed:
The weights are updated “real-time” after all demand arrival or tear down (only the aggregation had affects on routing).
The weights are updated after 10 or 50 or 100 events (demand arrivals or tear downs).

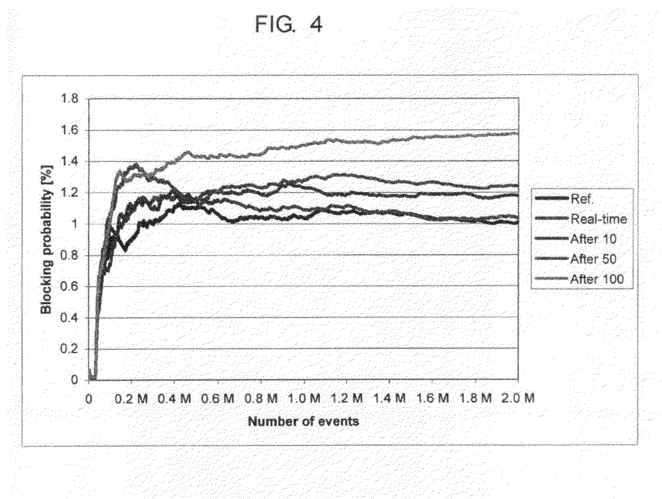

The load of the network was set to provide approximately 1% blocking in the reference case, when all topology information is known. It was found that the blocking probability can be kept in an acceptable level even if the updates come after 50 events. FIG. 4 shows how the blocking gets stabilized after the network is filled with demands (in FIG. 4, the elements in the legend on the right hand side are in reverse order to the plots on the right-most side of the graph). The blocking in the reference gets 1.01% and the real-time update in the aggregated network gets 1.04%. If the update comes after 10, 50 or 100 events, then the blocking gets 1.18%, 1.24% or 1.57%, respectively.

### Resilience Mechanism

The motivation in the construction of the resilience mechanism was twofold: to minimize the recovery time, and to keep the recovery mechanism as simple as possible.

The required recovery time of the domain-by-domain protection is much less than the recovery time of the end-to-end protection, since the domain-by-domain protection yields a “per-domain fast reroute” scheme containing many bypasses between the primary and the backup routes. On the other hand, important feature of the domain-by-domain protection is that the providers can handle the failure situations independently.

Capacity sharing between the intra- and inter-domain traffic protection depends on the length of the inter-domain protection path measured in the number of visited domains. If this number equals to the length of the primary (and the intra-domain protection) path or the following inequality is true, then the intra- and inter-domain backup traffic can share the resources by definition in practice

$$\frac{Inter Protection Length}{Primary Length} \leq \frac{\begin{matrix}Backup Inner traffic + \\ Backup Transit traffic\end{matrix}}{Backup Transit traffic} ,$$

where the inner traffic refers to a domain's own traffic and the transit traffic is traffic of the demands, which have intra-domain backup path and go through the particular domain. In other cases, the inter-domain protection needs additional resources compared to the intra-domain protection.

An embodiment of the present invention has one or more of the following advantages:
QoS can be guaranteed between the source node and the selected DBR of the destination domain. (If the QoS parameters between the DBRs of the destination domain and destination node can be used in the routing decision, then end-to-end QoS can be guaranteed.)
Relatively simple implementation. Only minor (software) changes/extensions are needed in routers and in routing protocols.
The proposed solution fits to multi-service, multi-domain, multi-provider environment and special requirements.
The proposed resilience mechanism provides a fast recovery mechanism, which fits to real-time applications.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method for use in a multi-domain network environment, comprising:
each domain of the multi-domain network collecting intra-domain routing information relating to that domain;
providing a reduced view of that information to other domains of the network, and
each domain of the network using its own intra-domain routing information together with the reduced-view routing information from the other domains to form a logical view of the network so as to enable that domain to make an end-to-end route selection decision.

2. The method as claimed in claim 1, wherein the logical view formed at each domain comprises a plurality of intra-domain links between respective pairs of nodes of that domain.

3. The method as claimed in claim 2, wherein each intra-domain link is a real and direct link between nodes.

4. The method as claimed in claim 1, wherein the logical view formed at each domain comprises a plurality of virtual intra-domain links for each other domain, each virtual link representing one or more real links.

5. The method as claimed in claim 4, wherein the reduced-view routing information made available by a domain comprises routing information relating to each of the virtual intra-domain links for that domain.

6. The method as claimed in claim 4, wherein the logical view formed at each domain comprises a plurality of inter-domain links between respective pairs of domain border routers.

7. The method as claimed in claim 6, wherein all domain border routers of the network appear in the logical view.

8. The method as claimed in claim 6, wherein the domain border routers are responsible for making the reduced-view information available to other domains of the network.

9. The method as claimed in claim 7, wherein each virtual link is between two different domain border routers associated with the domain concerned.

10. The method as claimed in claim 9, wherein the logical view formed at each domain comprises a full-mesh topology in relation to the domain border routers of the other domains.

11. The method as claimed in claim 4, wherein each link is associated with a respective administrative weight for use in the route selection decision.

12. The method as claimed in claim 11, wherein each administrative weight carries information about properties of each real link represented by that administrative weight.

13. The method as claimed in claim 12, wherein an administrative weight associated with a virtual link is determined based on a sum of the respective administrative weights of each real link represented by that virtual link.

14. The method as claimed in claim 13, wherein each virtual link represents a shortest path between the two end nodes for that link.

15. The method as claimed in claim 11, wherein each weight comprises a vector of weights.

16. The method as claimed in claim 11, wherein the domain border routers are responsible for determining the virtual links and calculating the weights.

17. The method as claimed in claim 11, when dependent on claim 4, wherein a respective scale value is maintained for each domain, with the weights in each domain being scaled in dependence on the scale value for that domain before use in the route selection decision.

18. The method as claimed in claim 11, when dependent on claim 1, wherein each virtual link is associated with a respective weight relating to a primary path for that virtual link and a different respective weight relating to a backup path for that virtual link.

19. The method as claimed in claim 18, wherein a route is selected taking account of both the primary path and the backup path of each virtual link on the route.

20. The method as claimed in claim 18, wherein a shared protection scheme is applied when calculating the backup path for each primary path.

21. The method as claimed in claim 2, wherein the traffic capacity of each link is allocated between a first part for handling primary traffic and a second part for handling backup traffic.

22. The method as claimed in claim 21, wherein the second part is shared between intra- and inter-domain protection.

23. The method as claimed in claim 1, wherein a communication failure occurring on the selected route within a domain is handled by that domain, independently of the other domains.

24. The method as claimed in claim 1, wherein a communication failure occurring on the selected route between domains is handled by an alternative end-to-end protection path.

25. The method as claimed in claim 1, wherein, if a problem is realised during resolution of the selected route, the originating node is notified and, unless the originating node accepts the problem, a new route is selected.

26. The method as claimed in claim 1, wherein the route selection decision is made according to a shortest path algorithm.

27. The [[A]] method as claimed in claim 1 any preceding claim, wherein each domain of the network is of a type that is not predisposed towards sharing its intra-domain routing information with other domains of the network.

28. The method as claimed in claim 1, wherein the route selection decision is based on Quality of Service.

29. The method as claimed in claim 1, wherein the intra-domain routing information for each domain also comprises resource information relating to that domain, so that the logical view of the network formed at each domain enables that domain to make an end-to-end route selection and resource allocation decision.

30. The method as claimed in claim 1, wherein at least some domains belong to different respective operators.

31. The method as claimed in claim 1, wherein a common intra-domain routing protocol is used in the network.

32. A multi-domain network in which each domain of the network is arranged to
collect intra-domain routing information relating to that domain and to make a reduced view of that information available to other domains of the network, and
use its own intra-domain routing information together with the reduced-view routing information from the other domains to form a logical view of the network so as to enable that domain to make an end-to-end route selection decision.

33. Apparatus for use in a domain of a multi-domain network, the apparatus being provided by one or more nodes of that domain and comprising
collection means for collecting intra-domain routing information relating to that domain,
view reduction means for making a reduced view of that information available to other domains of the network, and
aggregation means for forming a logical view of the network using the collected intra-domain routing information together with reduced-view routing information from the other domains so as to enable an end-to-end route selection decision to be made based on the logical view.

34. The apparatus as claimed in claim 33, wherein the apparatus is provided by one or more domain border routers of that domain.

35. The apparatus as claimed in claim 33, wherein the apparatus is provided by a single network node.

36-41. (canceled)
